(19) United States
(12) Patent Application Publication
(10) Pub. No.: US 2002/0144790 A1
(43) Pub. Date: Oct. 10, 2002

(54) Lever for lifting a tire bead

(76) Inventor: Rino Spaggiari, Correggio (IT)

Correspondence Address: BROWDY AND NEIMARK, P.L.L.C., 624 NINTH STREET, NW, SUITE 300, WASHINGTON, DC, 20001-5303, US

(21) Appl. No.: 10/116,785

(22) Filed: Apr. 5, 2002

(30) Foreign Application Priority Data
Apr. 6, 2001 (IT) MO2001U000013

(51) Int. Cl. B60C 25/04

(52) U.S. Cl. 157/1.3

(57) ABSTRACT

A lever for lifting a tire bead, having a shaped tire-lifting end for interacting with an appendix provided on a tire removing and fitting tool positioned close to a rim of a wheel hub on which a tire is to be removed, wherein a remaining part of the lever, destined to be gripped by an operator, exhibits an inclined geometrical axis having a predetermined inclination with respect to a work plane being a plane in which the shaped tire-lifting end of the lever rests upon the appendix of the tire removing and fitting tool.

### BACKGROUND OF THE INVENTION

Specifically, though not exclusively, the lever of the invention is usefully applied for raising a tire bead to start a tire-removal operation from a hub of a wheel mounted on a self-centering platform of a tire-changing machine provided with a tire-removing and fitting tool. An initial lifting of a point of the tire is aimed at hitching the point onto an appendix of the tire-removing and fitting tool, so that by effect of a subsequent rotation of the wheel on the platform the tire bead is gradually lifted until it is fully removed from the hub rim at completion of one revolution of the wheel.

The prior art has for a considerably long time taught levers for the purpose of lifting tires from rims, which are provided with a shaped “work” end exhibiting a curved part predisposed for interacting with an appendix usually provided on a tire-removal and fitting tool, which latter is positioned bear the rim of the wheel bearing the tire to be removed.

The tire-removal and fitting tool is normally fixed at the end of an arm which is parallel to the rotation axis of the platform the wheel is mounted on. The lever for raising the bead is, however, forced to work very closely to the arm during the lifting stage, so closely that in order to prevent the operator's hands from interfering with the tool arm, the lever is inclined with respect to the arm, and in a resultingly unnatural position for the best possible performance of the required task. The lifting operation is thus rendered more difficult, laborious and is indeed not without danger of injury for the operator.

The main aim of the present invention is to obviate the above drawbacks in the prior art.

An advantage of the invention is that it enables the bead to be lifted simply and with the least possible effort on the part of the operator, who can grip the lever in the simplest and most comfortable way.

A further advantage of the invention is that the bead of the tire is subjected to less traumatic flexion stress during the lifting procedure.

These aims and advantages and more besides are all achieved by the invention of the object, as it is characterized in the accompanying claims.

### SUMMARY OF THE INVENTION

The invention discloses a lever for lifting a tire bead, having a shaped tire-lifting end for interacting with an appendix provided on a tire removing and fitting tool positioned close to a rim of a wheel hub on which a tire is to be removed. A remaining part of the lever, destined to be gripped by an operator, exhibits an inclined geometrical axis having a predetermined inclination with respect to a work plane being a plane in which the shaped tire-lifting end of the lever rests upon the appendix of the tire removing and fitting tool.

### BRIEF DESCRIPTION OF THE DRAWINGS

Further characteristics and advantages of the present invention will better emerge from the detailed description which follows, of a preferred form of embodiment of the invention, illustrated purely by way of non-limiting example in the accompanying figures of the drawings, in which:

FIG. 1 is a schematic frontal view of the invention;

FIG. 2 is a schematic side view from the right of FIG. 1;

FIG. 3 is a lateral view of the application during a tire bead-lifting stage;

FIG. 4 is a perspective view of the situation featured in FIG. 3;

FIG. 5 is the same perspective view as in FIG. 4, in a different and subsequent stage of the tire bead-lifting operation.

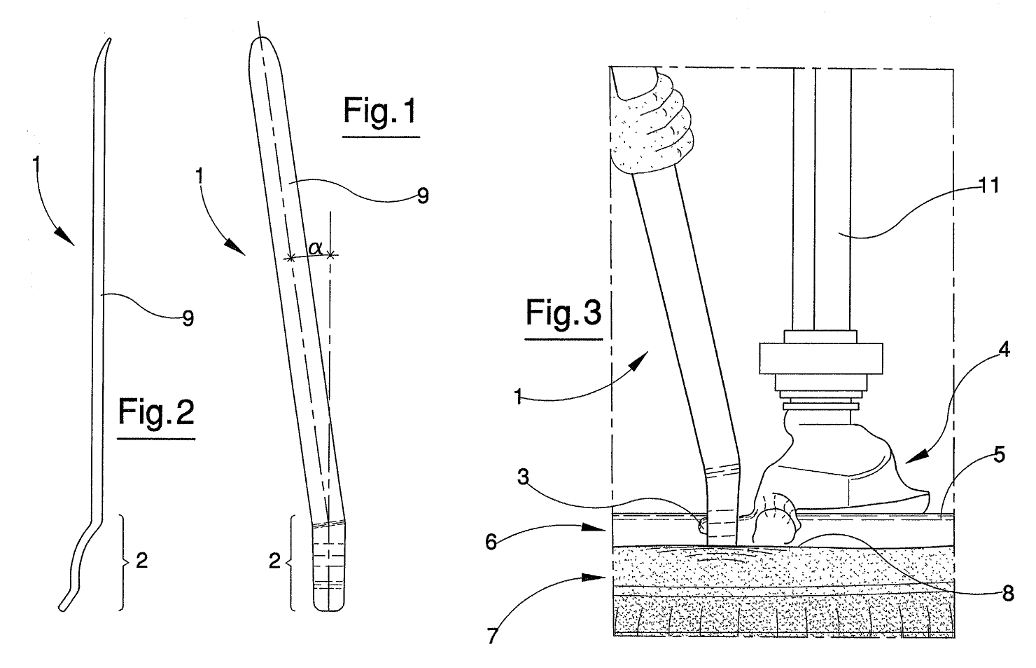

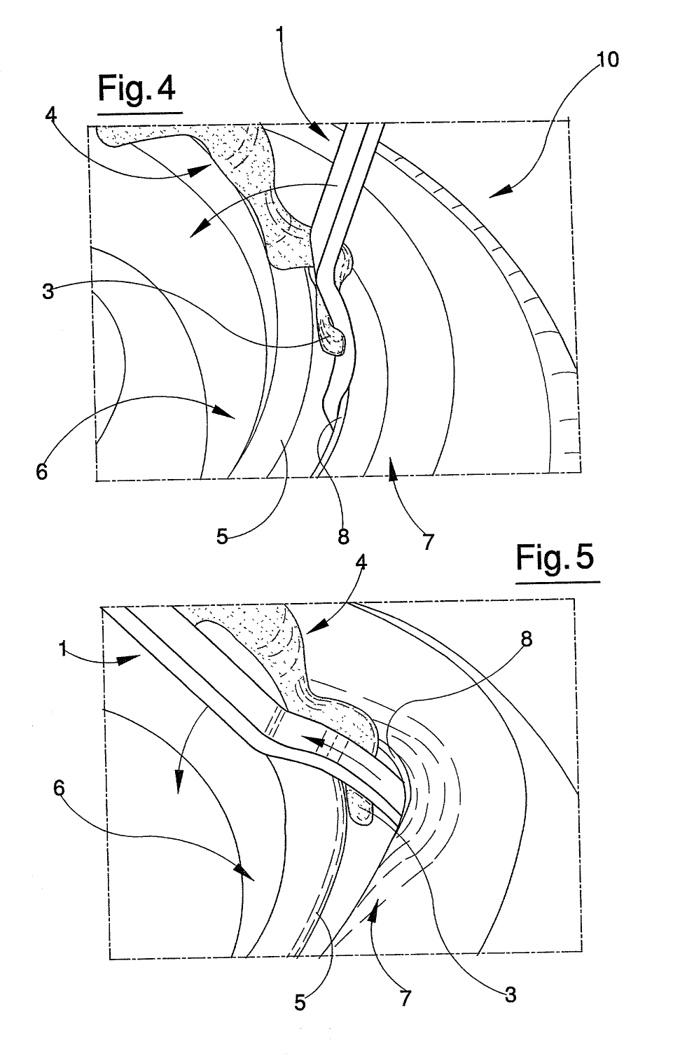

### DESCRIPTION OF THE PREFERRED EMBODIMENTS

With reference to the above-mentioned figures, 1 denotes in its entirety a lever for raising a bead 8 of a tire 7 of a wheel 10 mounted on a self-centering platform of a machine for fitting and removing tires, not shown in the figures of the drawings. The figures show only a part of the above-mentioned machine, namely a removing and fitting tool 4 which in most machines is normally fixed at an end of an arm 11 which is parallel to an axis of rotation of the platform on which the wheel 10 is mounted.

The removing and fitting tool 4 is positioned close to the rim 5 of the hub 6 from which the tire 7 is to be removed.

The lever 1 is provided with a shaped end 2 for interacting contactingly with an appendix 3 exhibited by the removing and fitting tool 4 positioned close to the rim 5 of the hub 6.

The remaining part 9 of the lever 1 destined to be gripped by the operator exhibits a geometrical axis having a predetermined inclination with respect to a work plane containing the shaped end 2 resting on the appendix 3.

The above-cited work plane is practically parallel to the axis of the arm 11 and coincides very closely to a diametric plane of the wheel 10.

The predetermined inclination, denoted by angle α, is determined in such a way that a distance between the axis of the remaining part 9 of the lever 1 destined to be gripped by the operator and the work plane is sufficient to enable the lever 1 to be rotated without there being any interference thereof with the structural elements—and especially with the arm 11—which support the removing and fitting tool 4.

The invention enables a point of the bead 8 to be lifted and slid onto the rounded surface of the appendix 3 of the removing and fitting tool 4, with a simple maneuver not requiring a special effort on the part of the operator, nor any fussy maneuvering for insertion of the removing and fitting tool 4. The invention is also very safe to use.

What is claimed:

1). A lever for lifting a tire bead, having a shaped tire-lifting end for interacting with an appendix provided on a tire removing and fitting tool positioned close to a rim of a wheel hub on which a tire is to be removed, wherein a remaining part of the lever, destined to be gripped by an operator, exhibits an inclined geometrical axis having a predetermined inclination with respect to a work plane being a plane in which the shaped tire-lifting end of the lever rests upon the appendix of the tire removing and fitting tool.

2). The lever of claim 1, wherein the predetermined inclination is determined in such a way that a distance between the inclined geometrical axis of the remaining part of the lever, destined to be gripped by the operator, and the work plane is sufficient to enable rotations of the lever with no ensuing interference between the lever and structural elements supporting the removing and fitting tool.
